(19) United States
(12) Patent Application Publication
(10) Pub. No.: US 2025/0358098 A1
(43) Pub. Date: Nov. 20, 2025

(54) HOST-SIDE CRYPTOGRAPHY FOR A MEMORY SYSTEM

(71) Applicant: Micron Technology, Inc., Boise, ID (US)

(72) Inventor: Christian M. Gyllenskog, Meridian, ID (US)

(21) Appl. No.: 19/195,450

(22) Filed: Apr. 30, 2025

Related U.S. Application Data
(60) Provisional application No. 63/649,900, filed on May 20, 2024.

(51) Int. Cl. H04L 9/06

(52) U.S. Cl. CPC H04L 9/06

(57) ABSTRACT

Methods, systems, and devices for host-side cryptography for a memory system are described. A memory system may receive, a command for a set of data, and an address payload comprising an indication of a register, of a host system, that stores cryptography instructions for the set of data. The memory system may transmit, to a cryptography engine of the host system, an indication of the command for the set of data, and the address payload comprising the indication of the register that stores the cryptography instructions. The memory system may communicate, between the memory system and the host system, the set of data based at least in part on transmitting the indication of the command and the address payload comprising the indication of the register that stores the cryptography instructions, where the set of data is encrypted according to the cryptography instructions.

### CROSS REFERENCE

The present Application for Patent claims priority to U.S. Patent Application No. 63/649,900 by Gyllenskog, entitled “HOST-SIDE CRYPTOGRAPHY FOR A MEMORY SYSTEM,” filed May 20, 2024, which is assigned to the assignee hereof, and which is expressly incorporated by reference in its entirety herein.

### TECHNICAL FIELD

The following relates to one or more systems for memory, including host-side cryptography for a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states if disconnected from an external power source.

### BRIEF DESCRIPTION OF THE DRAWINGS

FIG. 1 shows an example of a system that supports host-side cryptography for a memory system in accordance with examples as disclosed herein.

FIG. 2 shows an example of a system that supports host-side cryptography for a memory system in accordance with examples as disclosed herein.

FIG. 3 shows an example of a process flow that supports host-side cryptography for a memory system in accordance with examples as disclosed herein.

FIG. 4 shows an example of a process flow that supports host-side cryptography for a memory system in accordance with examples as disclosed herein.

FIG. 5 shows a block diagram of a memory system that supports host-side cryptography in accordance with examples as disclosed herein.

FIG. 6 shows a block diagram of a host system that supports host-side cryptography for a memory system in accordance with examples as disclosed herein.

FIGS. 7 and 8 show flowcharts illustrating a method or methods that support host-side cryptography for a memory system in accordance with examples as disclosed herein.

### DETAILED DESCRIPTION

A memory system, such as a non-volatile memory express (NVMe) system, may be used to store data for another device, such as a host system. To facilitate interoperability between the two systems, the memory system and the host system may use an interface protocol, such as the peripheral component interconnect express (PCIe) protocol, in which the memory system relays some host-originated control information to the host system, such as one or more subcomponents of the host system. The interface protocol may also be used for communicating data between the host system and the memory system. But the data communicated between the host system and the memory system may be unencrypted, which may jeopardize the security of the data at the memory system side and render the system unsuitable for some applications, such as high-security applications. Techniques for enabling host-side cryptography, in which data communicated between the host system and the memory system is encrypted and decrypted by the host system, may be desired.

According to the techniques described herein, a cryptography engine at the host system may be used to enable host-side cryptography. To facilitate use of the cryptography engine in accordance with the interface protocol used by the host system and the memory system—and enable use of different cryptography algorithms across different data sets—the host system may add a pointer to an address payload that is routed through the memory system back to the cryptography engine. The host system may include a set of registers each storing cryptography instructions, and the pointer may indicate a register that stores the cryptography instructions for encrypting and decrypting the data associated with the address payload. The cryptography engine may encrypt the data (e.g., in a write scenario) and/or decrypt the data (e.g., in a read scenario) in accordance with the cryptography instructions stored in the register.

In addition to applicability in memory systems described herein, techniques for host-side cryptography may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by limiting the exposure of encrypted data to memory systems, and may prevent or mitigate unauthorized access to data or other information, among other benefits.

Features of the disclosure are illustrated and described in the context of systems, devices, and circuits. Features of the disclosure are further illustrated and described in the context of process flows, device diagrams, and flowcharts.

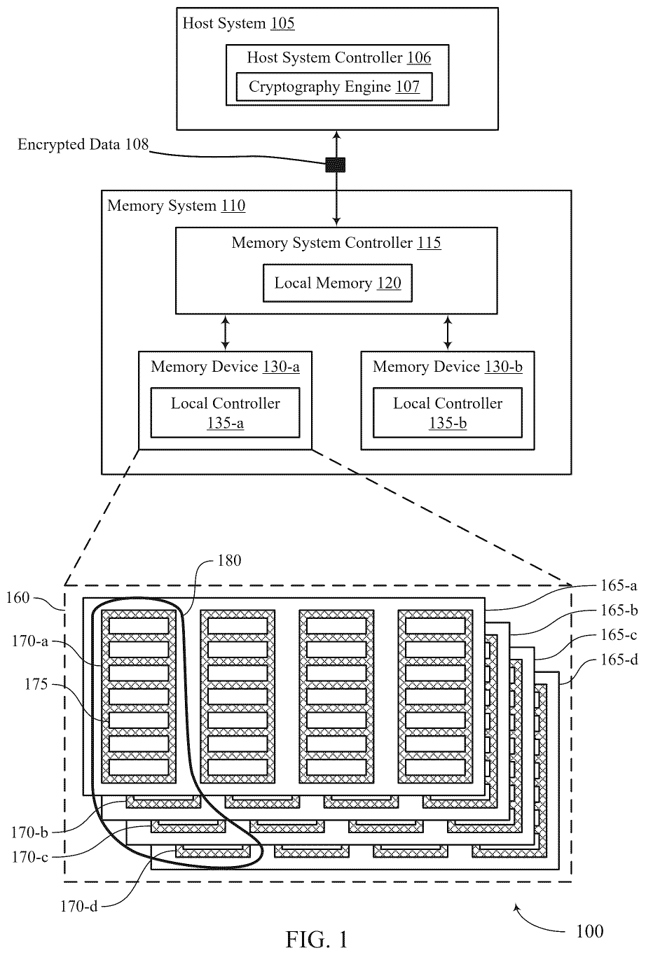

FIG. 1 shows an example of a system 100 that supports host-side cryptography for a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., a PCIe controller, a serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

To enable host-side cryptography, the host system 105 may include (e.g., as part of the host system controller 106), a cryptography engine 107 that is configured to perform cryptography operations (e.g., encryption, decryption) on data. Although shown integrated with the host system controller 106, the cryptography engine 107 may be separate from the host system controller 106. The cryptography engine 107 may include registers that store different sets of cryptography instructions (e.g., different cryptography algorithms). The host system 105 may instruct the cryptography engine 107 which set of cryptography instructions to use for a set of data by adding, to an address payload, a pointer that indicates the register. In addition to a corresponding access command for the set of data, the address payload may be communicated to the memory system 110 (in accordance with the interface protocol employed by the host system 105 and the memory system 110) and routed back to the cryptography engine 107. The cryptography engine 107 encrypt or decrypt (depending on the direction of data flow) the set of data according to the set of cryptography instructions in the indicate register. Thus, the cryptography engine 107 may be used to communicate encrypted data 108 between the host system 105 and the memory system 110.

The system 100 may include any quantity of non-transitory computer readable media that support host-side cryptography for a memory system. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

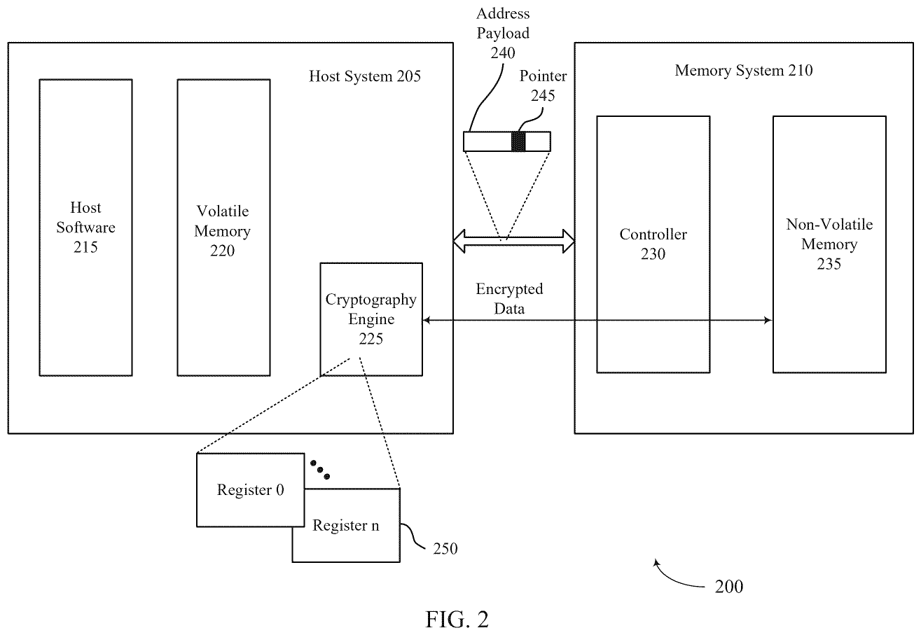

FIG. 2 shows an example of a system 200 that supports host-side cryptography for a memory system in accordance with examples as disclosed herein. The system 200 may be an example of a system 100 as described with reference to FIG. 1, or aspects thereof. The system 200 may implement aspects of the system 100 as described with reference to FIG. 1. For example, the memory system 210 and the host system 205 may be examples of the memory system 110 and the host system 105, respectively. The host system 205 may include a cryptography engine 225, which may be configured to perform cryptography operations on data communicated between the host system 205 and the memory system 210. The cryptography engine 225 may also be referred to as an in-line cryptography engine or other suitable terminology.

The memory system 210 may be configured to store encrypted data received from the host system 205 and to send encrypted data to the host system 205, if requested by the host system 205 using access commands (e.g., read commands, write commands). A read command may refer to any command that indicates a set of data to be read from the non-volatile memory 235 and may include a PCIe scatter/gather list command. A write command may refer to any command that indicates a set of data to be written to the non-volatile memory 235 and may include a PCIe scatter/gather list command. Unencrypted data (also referred to as “clear” data) for transmission to the memory system 210 (e.g., for a write operation) or received from the memory system 210 (e.g., for a read operation) may be stored in the volatile memory 220, which may be coupled with the cryptography engine 225.

The host system 205 and the memory system 210 may use an interface protocol, such as PCIe, that routes (e.g., using one or more ports) control information generated by the host software 215 to the controller 230 of the memory system 210 (potentially through the volatile memory 220). For example, the host system 205 may transmit an access command (e.g., a read command, a write command) for a set of data and a corresponding address payload 240 to the controller 230. According to the interface protocol, the controller 230 may relay at least some of the control information to the cryptography engine 225. In some examples, the control information may include a logical address that the memory system 210 uses to find (e.g., via an L2P table) the physical address (of the non-volatile memory 235) associated with the set of data.

The address payload 240 for a set of data may include a set of bits that indicate an address of the volatile memory 220 (referred to as a volatile memory address) for storing a set of data that is received from the memory system 210 (e.g., for a read operation) or that is for transmission to the memory system 210 (e.g., for a write operation). The cryptography engine 225 may use the set of bits to locate the set of memory cells involved in reading or writing the set of data. For example, in a read operation, the cryptography engine 225 may retrieve the set of data by reading the set of data from the set of memory cells corresponding to the volatile memory address. In a write operation, the cryptography engine 225 may store the set of data by writing the set of data to the set of memory cells corresponding to the volatile memory address.

The address payload 240 may also include a pointer (e.g., set of one or more bits) that indicates a register 250 that stores cryptography instructions for performing a cryptography operation on the set of data, where examples of cryptography operations include encryption operations and decryption operations. Each register 250 (e.g., register 0 through register n) may store a different set of cryptography instructions so that different encryption can be used on different sets of data. Although shown included in the cryptography engine 225, the registers 250 may be separate from, but coupled with, the cryptography engine 225. Use of a pointer may allow the host system 205 to control the encryption of data without transmitting sets of cryptography instructions (which may be much larger in size than the pointer). In some examples, the address payload 240 may also include a prefix (e.g., set of bits) for routing the address payload 240 between the host system 205 and the memory system 210. In some examples, a pointer may also be referred to as a set of address alias bits (AABs), a context, or other suitable terminology.

In some examples, the security of the system 200 may be further strengthened by the host system 205 encrypting the address payload 240 before communicating the address payload 240 to the memory system 210. For example, the host software 215 or the cryptography engine 225 may encrypt the address payload 240 using a set of cryptography instructions that is associated with address payloads. The set of cryptography instructions may be previously indicated to the cryptography engine 225 (e.g., the host software 215 may indicate to the cryptography engine 225 that the set of cryptography instructions is to be used for address payloads). Accordingly, the cryptography engine 225 may decrypt the address payload 240 to recover the volatile memory address and the pointer 245. Such a technique may be supported because the address payload 240 may be opaque (e.g., unknown) to the memory system 210, and thus the memory system 210 may relay the encrypted address payload 240 to the cryptography engine 225 without decrypting the encrypted address payload 240.

Thus, host-side cryptography may be implemented by having the cryptography engine 225 perform cryptography operations on data communicated between the host system 205 and the memory system 210.

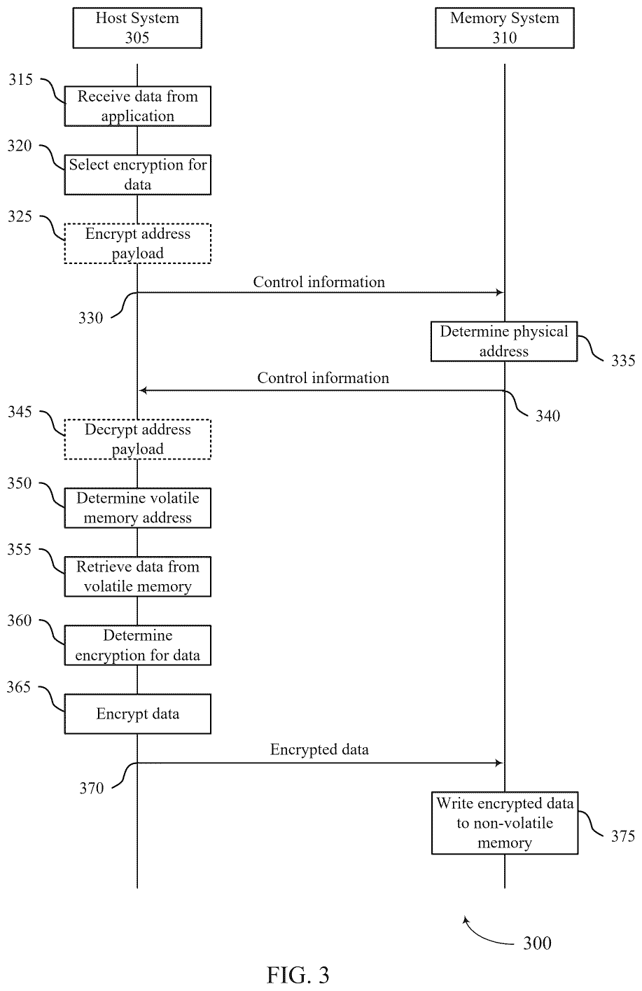

FIG. 3 shows an example of a process flow 300 that supports host-side cryptography for a memory system in accordance with examples as disclosed herein. The process flow 300 may be implemented by a host system 305 (e.g., via one or more controllers such as the host system controller 106), which may be an example of a host system 105 or a host system 205, and a memory system 310 (e.g., via one or more controllers such as the memory system controller 115), which may be an example of a memory system 110 or a memory system 210. The process flow 300 may be an example of a process flow for a write operation in which host-side encryption is performed on the data involved in the write operation.

At 315, a system, such as the host system 305, may receive from an application data that is for writing to another system, such as the memory system 315. The host system 305 may write the data to a location of a volatile memory (e.g., volatile memory 220) of the host system 305. At 320, a system such as the host system 305 may select a set of cryptography instructions for encrypting the data. The set of cryptography instructions may be stored in a register (e.g., a register 250) of the host system 305.

At 325, a system, such as the host system 305, may (e.g., via the host software 215 or cryptography engine 225) encrypt an address payload associated with the data. For example, the host system 305 may encrypt the address payload using a set of cryptography instructions that is associated with address payloads. The address payload may include a volatile memory address that indicates the location in the volatile memory (e.g., volatile memory 220) of the host system 305 that is temporarily storing the data to be written to the memory system 310. The address payload may also include a pointer that indicates the register that stores the set of cryptography instructions selected at 320. The address payload may also include a set of bits for routing the address payload between the host system 305 and the memory system 310.

At 330, a system, such as the host system 305, may transmit control information to, for example, the memory system 310. The control information may include a command for the memory system 310 to write the data. The control information may also include the address payload. In some examples, the control information may also include a logical address associated with the data.

At 335, a system such as the memory system 310 may determine a physical address associated with (e.g., mapped to) the logical address. The physical address may be for a set memory cells of the non-volatile memory.

At 340, a system, such as the memory system 310, transmit control information to, for example, the host system 305. The control information may include an indication of the command and may also include at least a portion of the address payload (e.g., the volatile memory address, the pointer). If the address payload is encrypted, the memory system 310 may relay the address payload to the host system 305 without decrypting the address payload.

At 345, a system, such as the host system 305, may (e.g., via the cryptography engine 225) decrypt the address payload if the address payload is encrypted. The cryptography engine 225 may decrypt the address payload based on (e.g., in accordance with) the set of cryptography instructions associated with (e.g., assigned to, indicated for) address payloads.

At 350, a system, such as the host system 305, may determine (e.g., from the address payload) the volatile memory address of the set of memory cells that stores data to be written to, for example, the memory system 310. At 355, a system such as the host system 305 may retrieve the data from the volatile memory. For example, the host system 305 may instruct the memory to read and provide the data stored at the volatile memory address determined at 350.

At 360, a system, such as the host system 305, may determine a set of cryptography instructions for the data. For example, the host system 305 may identify the register indicated by the pointer and may determine to encrypt the data using the set of cryptography instructions stored in the register indicated by the pointer. At 365, a system such as the host system 305 may encrypt the data based on (e.g., in accordance with) the set of cryptography instructions. At 370, a system such as the host system 305 may transmit the encrypted data to the memory system 310, potentially with additional control information (e.g., a write command, the logical address). At 375, a system such as the memory system 310 may write the encrypted data to the physical address associated with the logical address.

Thus, host-side encryption may be performed on data that is involved in a write operation. Aspects of the process flow 300 may be implemented by one or more controllers, among other components. Additionally, or alternatively, aspects of the process flow 300 may be implemented as instructions stored in one or more memories (e.g., firmware stored in one or more memories coupled with the host system 305 and the memory system 310). For example, the instructions, if executed by one or more controllers (e.g., the host system controller 106, the memory system controller 115), may cause the one or more controllers (or a device or a system) to perform the operations of the process flow 300.

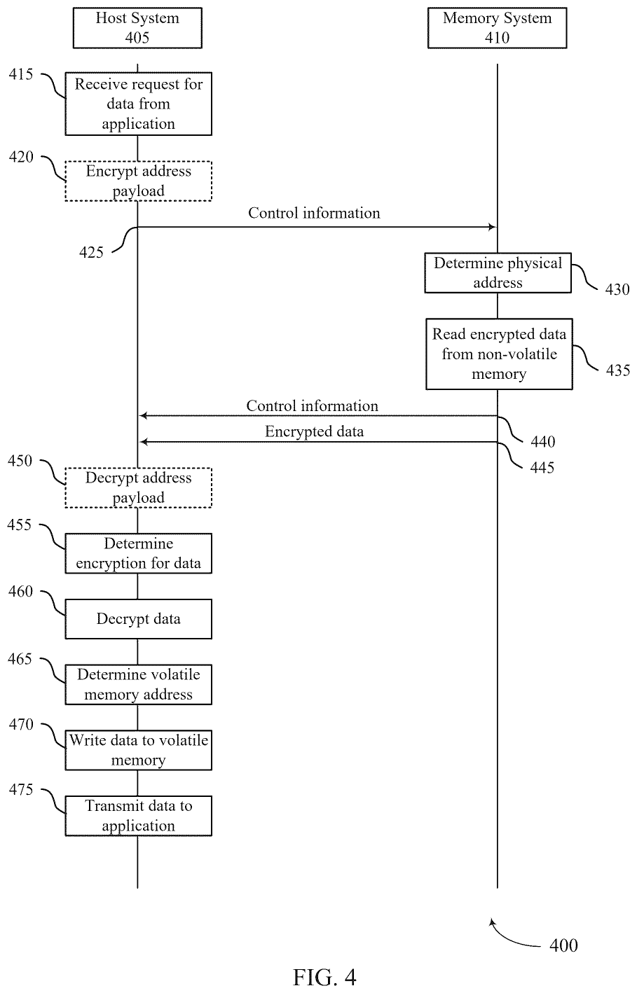

FIG. 4 shows an example of a process flow 400 that supports host-side cryptography for a memory system in accordance with examples as disclosed herein. Aspects of the process flow 400 may be implemented by a host system 405 (e.g., via one or more controllers such as the host system controller 106), which may be an example of a host system 105, a host system 205, or host system 305. Aspects of the process flow 400 may also be performed by a memory system 410 (e.g., via one or more controllers such as the memory system controller 115), which may be an example of a memory system 110, a memory system 210, or a memory system 310. The process flow 400 may be an example of a process flow for a read operation in which host-side decryption is performed on the data involved in the read operation. In some examples, the read operation is for the data written in the process flow 300.

At 415, a system, such as the host system 405, may receive from an application data a request for data that is stored in, for example, the memory system 410. At 420, a system such as the host system 405 may (e.g., via the host software 215 or cryptography engine 225) encrypt an address payload associated with the data. For example, the host system 405 may encrypt the address payload using a set of cryptography instructions that is associated with address payloads. The address payload may include a volatile memory address that indicates the location in the volatile memory (e.g., volatile memory 220) of the host system 405 that is for temporarily storing the data from the memory system 410. The address payload may also include a pointer that indicates a register that stores a set of cryptography instructions for the data. The address payload may also include a set of bits for routing the address payload between the host system 405 and the memory system 410.

At 425, a system, such as the host system 405, may transmit control information to, for example, the memory system 410. The control information may include a command for the memory system 410 to read the data. The control information may also include the address payload. In some examples, the control information may also include a logical address associated with the data.

At 430, a system, such as the memory system 410, may determine a physical address associated with (e.g., mapped to) the logical address. The physical address may be for a set memory cells (of the non-volatile memory) that store the data. At 435, a system such as the memory system 410 may (e.g., in response to the control information) read the data, which is encrypted, from the set of memory cells with the physical address.

At 440, a system, such as the memory system 410, transmit control information to, for example, the host system 405. The control information may include an indication of the command and may also include at least a portion of the address payload (e.g., the volatile memory address, the pointer). If the address payload is encrypted, the memory system 410 may relay the address payload to the host system 405 without decrypting the address payload. At 445, a system such as the memory system 410 may transmit the data, which is encrypted, to the host system 405.

At 450, a system, such as the host system 405, may (e.g., via the cryptography engine 225) decrypt the address payload if the address payload is encrypted. The cryptography engine 225 may decrypt the address payload based on (e.g., in accordance with) the set of cryptography instructions associated with (e.g., assigned to, indicated for) address payloads.

At 455, a system, such as the host system 405, may determine a set of cryptography instructions for the data. For example, the host system 405 may identify the register indicated by the pointer and may determine to decrypt the data using the set of cryptography instructions stored in the register indicated by the pointer.

At 460, a system, such as the host system 405, may decrypt the data based on (e.g., in accordance with) the set of cryptography instructions. At 465, a system, such as the host system 405, may determine (e.g., from the address payload) the volatile memory address of the set of memory cells for temporarily storing the decrypted data. At 470, a system, such as the host system 405, may write the data to, for example, the volatile memory. For example, the host system 405 may provide the data to the volatile memory and may instruct the volatile memory to write the data to volatile memory address determined at 465. At 475, a system such as the host system 405 may transmit the data to the application.

Thus, host-side decryption may be performed on data that is involved in a read operation. Aspects of the process flow 400 may be implemented by one or more controllers, among other components. Additionally, or alternatively, aspects of the process flow 400 may be implemented as instructions stored in one or more memories (e.g., firmware stored in one or more memories coupled with the host system 405 and the memory system 410). For example, the instructions, if executed by one or more controllers (e.g., the host system controller 106, the memory system controller 115), may cause the one or more controllers (or a device or a system) to perform the operations of the process flow 400.

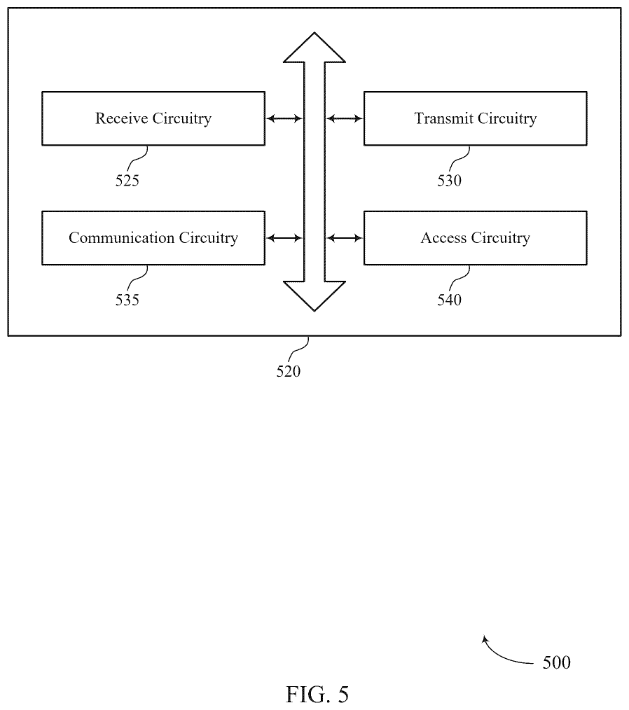

FIG. 5 shows a block diagram 500 of a memory system 520 that supports host-side cryptography for a memory system in accordance with examples as disclosed herein. The memory system 520 may be an example of aspects of a memory system as described with reference to FIGS. 1 through 4. The memory system 520, or various components thereof, may be an example of means for performing various aspects of host-side cryptography for a memory system as described herein. For example, the memory system 520 may include a receive circuitry 525, a transmit circuitry 530, a communication circuitry 535, an access circuitry 540, or any combination thereof. Each of these components, or components of subcomponents thereof (e.g., one or more processors, one or more memories), may communicate, directly or indirectly, with one another (e.g., via one or more buses).

The receive circuitry 525 may be configured as or otherwise support a means for receiving, from a host system, a command for a set of data, and an address payload including an indication of a register, of the host system, that stores cryptography instructions for the set of data. The transmit circuitry 530 may be configured as or otherwise support a means for transmitting, to a cryptography engine of the host system, an indication of the command for the set of data, and the address payload including the indication of the register that stores the cryptography instructions. The communication circuitry 535 may be configured as or otherwise support a means for communicating, between the memory system and the host system, the set of data based at least in part on transmitting the indication of the command and the address payload including the indication of the register that stores the cryptography instructions, where the set of data is encrypted according to the cryptography instructions.

In some examples, the address payload includes an address, for a volatile memory of the host system, from which the host system is to retrieve the set of data.

In some examples, the command is a command to write the set of data. In some examples, communication of the set of data includes the set of data being received from the host system.

In some examples, the receive circuitry 525 may be configured as or otherwise support a means for receiving a logical address associated with the encrypted set of data. In some examples, the access circuitry 540 may be configured as or otherwise support a means for writing the encrypted set of data to a set of memory cells, of one or more non-volatile memory devices, mapped to the logical address.

In some examples, the address payload includes an address, for a volatile memory of the host system, at which the host system is to store the set of data.

In some examples, the command is a command to read the set of data. In some examples, communication of the set of data includes the set of data being transmitted to the host system.

In some examples, the receive circuitry 525 may be configured as or otherwise support a means for receiving a logical address associated with the encrypted set of data. In some examples, the access circuitry 540 may be configured as or otherwise support a means for reading the encrypted set of data from a set of memory cells, of one or more non-volatile memory devices, mapped to the logical address.

In some examples, the address payload is encrypted, and the transmit circuitry 530 may be configured as or otherwise support a means for transmitting the address payload to the host system without decrypting the address payload.

In some examples, the address payload includes a set of bits for routing the address payload between the host system and the memory system.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

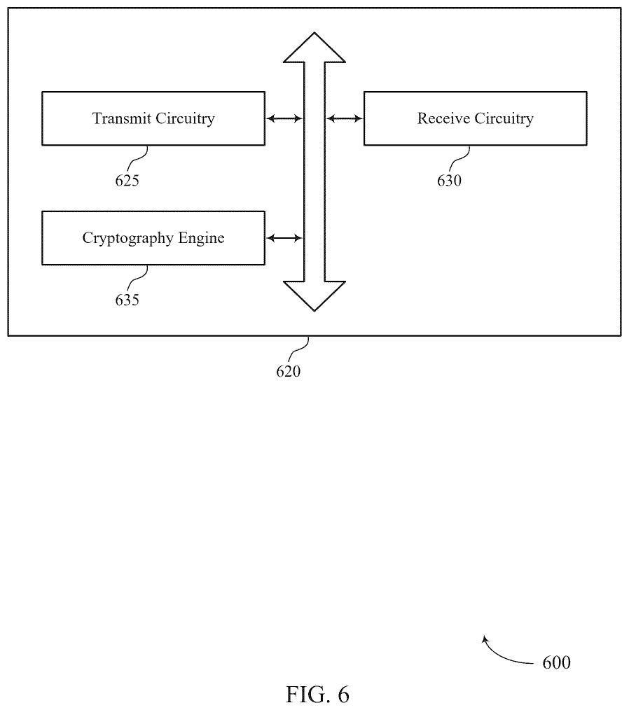

FIG. 6 shows a block diagram 600 of a host system 620 that supports host-side cryptography for a memory system in accordance with examples as disclosed herein. The host system 620 may be an example of aspects of a host system as described with reference to FIGS. 1 through 4. The host system 620, or various components thereof, may be an example of means for performing various aspects of host-side cryptography for a memory system as described herein. For example, the host system 620 may include a transmit circuitry 625, a receive circuitry 630, a cryptography engine 635, or any combination thereof. Each of these components, or components of subcomponents thereof (e.g., one or more processors, one or more memories), may communicate, directly or indirectly, with one another (e.g., via one or more buses).

The transmit circuitry 625 may be configured as or otherwise support a means for transmitting, to a memory system, a command for a set of data, and an address payload including an indication of a register, of the host system, that stores cryptography instructions for the set of data. The receive circuitry 630 may be configured as or otherwise support a means for receiving, at a cryptography engine of the host system, an indication of the command for the set of data, and the address payload including the indication of the register that stores the cryptography instructions. The cryptography engine 635 may be configured as or otherwise support a means for performing a cryptography operation on the set of data according to the cryptography instructions based at least in part on receiving the indication of the command and the address payload including the indication of the register that stores the cryptography instructions.

In some examples, the address payload includes a set of bits for routing the address payload between the host system and the memory system.

In some examples, the address payload is encrypted, and the cryptography engine 635 may be configured as or otherwise support a means for decrypting the address payload before performing the cryptography operation on the set of data and based at least in part on second cryptography instructions associated with address payloads.

In some examples, the address payload includes an address, for a volatile memory of the host system, from which the host system is to retrieve the set of data.

In some examples, the command is a command to write the set of data, and the cryptography engine 635 may be configured as or otherwise support a means for retrieving the set of data from the volatile memory based at least in part on the address, and to perform the cryptography operation, the cryptography engine 635 may be configured as or otherwise support a means for encrypting the set of data retrieved from the volatile memory.

In some examples, the transmit circuitry 625 may be configured as or otherwise support a means for transmitting a logical address associated with the encrypted set of data. In some examples, the transmit circuitry 625 may be configured as or otherwise support a means for transmitting the encrypted set of data to the memory system based at least in part on transmitting the logical address.

In some examples, the address payload includes an address, for a volatile memory of the host system, at which the host system is to store the set of data.

In some examples, the set of data is encrypted and the command is a command to read the encrypted set of data, and the cryptography engine 635 may be configured as or otherwise support a means for decrypting the encrypted set of data from the memory system.

In some examples, the transmit circuitry 625 may be configured as or otherwise support a means for transmitting a logical address associated with the encrypted set of data. In some examples, the receive circuitry 630 may be configured as or otherwise support a means for receiving the encrypted set of data from the memory system based at least in part on transmitting the logical address.

In some examples, the described functionality of the host system 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the host system 620, or various components thereof, may be implemented at least in part by instructions (e.g., stored in memory, non-transitory computer-readable medium) executable by such at least one processor.

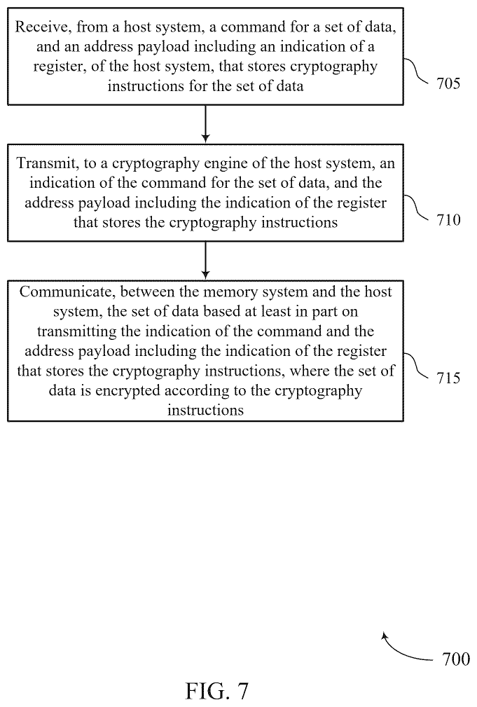

FIG. 7 shows a flowchart illustrating a method 700 that supports host-side cryptography for a memory system in accordance with examples as disclosed herein. The operations of method 700 may be implemented by a memory system or its components as described herein. For example, the operations of method 700 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 705, the method may include receiving, from a host system, a command for a set of data, and an address payload including an indication of a register, of the host system, that stores cryptography instructions for the set of data. In some examples, aspects of the operations of 705 may be performed by a receive circuitry 525 as described with reference to FIG. 5.

At 710, the method may include transmitting, to a cryptography engine of the host system, an indication of the command for the set of data, and the address payload including the indication of the register that stores the cryptography instructions. In some examples, aspects of the operations of 710 may be performed by a transmit circuitry 530 as described with reference to FIG. 5.

At 715, the method may include communicating, between the memory system and the host system, the set of data based at least in part on transmitting the indication of the command and the address payload including the indication of the register that stores the cryptography instructions, where the set of data is encrypted according to the cryptography instructions. In some examples, aspects of the operations of 715 may be performed by a communication circuitry 535 as described with reference to FIG. 5.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving, from a host system, a command for a set of data, and an address payload including an indication of a register, of the host system, that stores cryptography instructions for the set of data; transmitting, to a cryptography engine of the host system, an indication of the command for the set of data, and the address payload including the indication of the register that stores the cryptography instructions; and communicating, between the memory system and the host system, the set of data based at least in part on transmitting the indication of the command and the address payload including the indication of the register that stores the cryptography instructions, where the set of data is encrypted according to the cryptography instructions.

Aspect 2: The method, apparatus, or non-transitory computer-readable medium of aspect 1, where the address payload includes an address, for a volatile memory of the host system, from which the host system is to retrieve the set of data.

Aspect 3: The method, apparatus, or non-transitory computer-readable medium of aspect 2, where the command is a command to write the set of data and communication of the set of data includes the set of data being received from the host system.

Aspect 4: The method, apparatus, or non-transitory computer-readable medium of any of aspects 2 through 3, further including operations, features, circuitry, logic, means, or instructions, or any combination thereof for receiving a logical address associated with the encrypted set of data and writing the encrypted set of data to a set of memory cells, of one or more non-volatile memory devices, mapped to the logical address.

Aspect 5: The method, apparatus, or non-transitory computer-readable medium of any of aspects 1 through 4, where the address payload includes an address, for a volatile memory of the host system, at which the host system is to store the set of data.

Aspect 6: The method, apparatus, or non-transitory computer-readable medium of aspect 5, where the command is a command to read the set of data and communication of the set of data includes the set of data being transmitted to the host system.

Aspect 7: The method, apparatus, or non-transitory computer-readable medium of any of aspects 5 through 6, further including operations, features, circuitry, logic, means, or instructions, or any combination thereof for receiving a logical address associated with the encrypted set of data and reading the encrypted set of data from a set of memory cells, of one or more non-volatile memory devices, mapped to the logical address.

Aspect 8: The method, apparatus, or non-transitory computer-readable medium of any of aspects 1 through 7, where the address payload is encrypted and the method, apparatuses, and non-transitory computer-readable medium further includes operations, features, circuitry, logic, means, or instructions, or any combination thereof for transmitting the address payload to the host system without decrypting the address payload.

Aspect 9: The method, apparatus, or non-transitory computer-readable medium of any of aspects 1 through 8, where the address payload includes a set of bits for routing the address payload between the host system and the memory system.

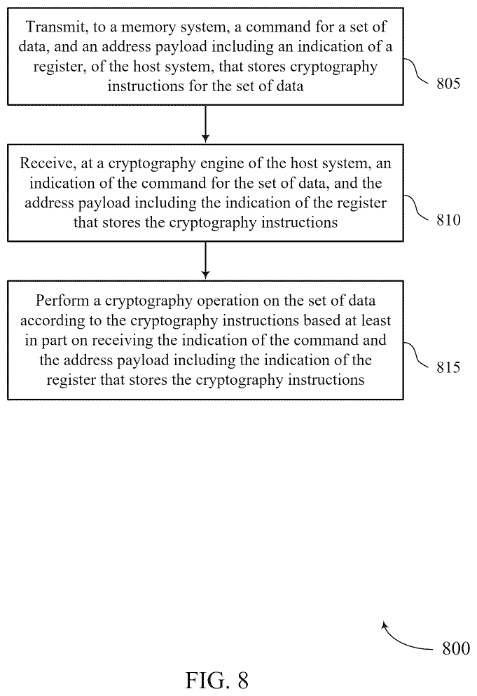

FIG. 8 shows a flowchart illustrating a method 800 that supports host-side cryptography for a memory system in accordance with examples as disclosed herein. The operations of method 800 may be implemented by a host system or its components as described herein. For example, the operations of method 800 may be performed by a host system as described with reference to FIGS. 1 through 4 and 6. In some examples, a host system may execute a set of instructions to control the functional elements of the device to perform the described functions. Additionally, or alternatively, the host system may perform aspects of the described functions using special-purpose hardware.

At 805, the method may include transmitting, to a memory system, a command for a set of data, and an address payload including an indication of a register, of the host system, that stores cryptography instructions for the set of data. In some examples, aspects of the operations of 805 may be performed by a transmit circuitry 625 as described with reference to FIG. 6.

At 810, the method may include receiving, at a cryptography engine of the host system, an indication of the command for the set of data, and the address payload including the indication of the register that stores the cryptography instructions. In some examples, aspects of the operations of 810 may be performed by a receive circuitry 630 as described with reference to FIG. 6.

At 815, the method may include performing a cryptography operation on the set of data according to the cryptography instructions based at least in part on receiving the indication of the command and the address payload including the indication of the register that stores the cryptography instructions. In some examples, aspects of the operations of 815 may be performed by a cryptography engine 635 as described with reference to FIG. 6.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:

Aspect 10: A method, apparatus, or non-transitory computer-readable medium including operations, features, circuitry, logic, means, or instructions, or any combination thereof for transmitting, to a memory system, a command for a set of data, and an address payload including an indication of a register, of the host system, that stores cryptography instructions for the set of data; receiving, at a cryptography engine of the host system, an indication of the command for the set of data, and the address payload including the indication of the register that stores the cryptography instructions; and performing a cryptography operation on the set of data according to the cryptography instructions based at least in part on receiving the indication of the command and the address payload including the indication of the register that stores the cryptography instructions.

Aspect 11: The method, apparatus, or non-transitory computer-readable medium of aspect 10, where the address payload includes a set of bits for routing the address payload between the host system and the memory system.

Aspect 12: The method, apparatus, or non-transitory computer-readable medium of any of aspects 10 through 11, where the address payload is encrypted and the method, apparatuses, and non-transitory computer-readable medium further includes operations, features, circuitry, logic, means, or instructions, or any combination thereof for decrypting the address payload before performing the cryptography operation on the set of data and based at least in part on second cryptography instructions associated with address payloads.

Aspect 13: The method, apparatus, or non-transitory computer-readable medium of any of aspects 10 through 12, where the address payload includes an address, for a volatile memory of the host system, from which the host system is to retrieve the set of data.

Aspect 14: The method, apparatus, or non-transitory computer-readable medium of aspect 13, where the command is a command to write the set of data and the method, apparatuses, and non-transitory computer-readable medium further includes operations, features, circuitry, logic, means, or instructions, or any combination thereof for retrieving the set of data from the volatile memory based at least in part on the address, where performing the cryptography operation includes encrypting the set of data retrieved from the volatile memory.

Aspect 15: The method, apparatus, or non-transitory computer-readable medium of any of aspects 13 through 14, further including operations, features, circuitry, logic, means, or instructions, or any combination thereof for transmitting a logical address associated with the encrypted set of data and transmitting the encrypted set of data to the memory system based at least in part on transmitting the logical address.

Aspect 16: The method, apparatus, or non-transitory computer-readable medium of any of aspects 10 through 15, where the address payload includes an address, for a volatile memory of the host system, at which the host system is to store the set of data.

Aspect 17: The method, apparatus, or non-transitory computer-readable medium of aspect 16, where the set of data is encrypted and the command is a command to read the encrypted set of data and the method, apparatuses, and non-transitory computer-readable medium further includes operations, features, circuitry, logic, means, or instructions, or any combination thereof for decrypting the encrypted set of data from the memory system.

Aspect 18: The method, apparatus, or non-transitory computer-readable medium of any of aspects 16 through 17, further including operations, features, circuitry, logic, means, or instructions, or any combination thereof for transmitting a logical address associated with the encrypted set of data and receiving the encrypted set of data from the memory system based at least in part on transmitting the logical address.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more non-volatile memory devices; and
one or more controllers coupled with the one or more non-volatile memory devices and configured to cause the memory system to:
receive, from a host system, a command for a set of data, and an address payload comprising an indication of a register, of the host system, that stores cryptography instructions for the set of data;
transmit, to a cryptography engine of the host system, an indication of the command for the set of data, and the address payload comprising the indication of the register that stores the cryptography instructions; and
communicate, between the memory system and the host system, the set of data based at least in part on transmitting the indication of the command and the address payload comprising the indication of the register that stores the cryptography instructions, wherein the set of data is encrypted according to the cryptography instructions.

2. The memory system of claim 1, wherein the address payload comprises an address, for a volatile memory of the host system, from which the host system is to retrieve the set of data.

3. The memory system of claim 2, wherein the command is a command to write the set of data, and wherein communication of the set of data comprises the set of data being received from the host system.

4. The memory system of claim 2, wherein the one or more controllers is further configured to cause the memory system to:
receive a logical address associated with the encrypted set of data; and
write the encrypted set of data to a set of memory cells, of the one or more non-volatile memory devices, mapped to the logical address.

5. The memory system of claim 1, wherein the address payload comprises an address, for a volatile memory of the host system, at which the host system is to store the set of data.

6. The memory system of claim 5, wherein the command is a command to read the set of data, and wherein communication of the set of data comprises the set of data being transmitted to the host system.

7. The memory system of claim 5, wherein the one or more controllers is further configured to cause the memory system to:
receive a logical address associated with the encrypted set of data; and
read the encrypted set of data from a set of memory cells, of the one or more non-volatile memory devices, mapped to the logical address.

8. The memory system of claim 1, wherein the address payload is encrypted, and wherein the one or more controllers is further configured to cause the memory system to:
transmit the address payload to the host system without decrypting the address payload.

9. The memory system of claim 1, wherein the address payload comprises a set of bits for routing the address payload between the host system and the memory system.

10. A host system, comprising:
one or more volatile memory devices; and
one or more controllers coupled with the one or more volatile memory devices and configured to cause the host system to:
transmit, to a memory system, a command for a set of data, and an address payload comprising an indication of a register, of the host system, that stores cryptography instructions for the set of data;
receive, at a cryptography engine of the host system, an indication of the command for the set of data, and the address payload comprising the indication of the register that stores the cryptography instructions; and
perform a cryptography operation on the set of data according to the cryptography instructions based at least in part on receiving the indication of the command and the address payload comprising the indication of the register that stores the cryptography instructions.

11. The host system of claim 10, wherein the address payload comprises a set of bits for routing the address payload between the host system and the memory system.

12. The host system of claim 10, wherein the address payload is encrypted, and wherein the one or more controllers is further configured to cause the host system to:
decrypt the address payload before performing the cryptography operation on the set of data and based at least in part on second cryptography instructions associated with address payloads.

13. The host system of claim 10, wherein the address payload comprises an address, for a volatile memory of the host system, from which the host system is to retrieve the set of data.

14. The host system of claim 13, wherein the command is a command to write the set of data, and wherein the one or more controllers is further configured to cause the host system to:
retrieve the set of data from the volatile memory based at least in part on the address, and wherein performing the cryptography operation comprises:
encrypt the set of data retrieved from the volatile memory.

15. The host system of claim 14, wherein the one or more controllers is further configured to cause the host system to:
transmit a logical address associated with the encrypted set of data; and
transmit the encrypted set of data to the memory system based at least in part on transmitting the logical address.

16. The host system of claim 10, wherein the address payload comprises an address, for a volatile memory of the host system, at which the host system is to store the set of data.

17. The host system of claim 16, wherein the set of data is encrypted and the command is a command to read the encrypted set of data, and wherein performing the cryptography operation comprises:
decrypt the encrypted set of data from the memory system.

18. The host system of claim 17, wherein the one or more controllers is further configured to cause the host system to:
transmit a logical address associated with the encrypted set of data; and
receive the encrypted set of data from the memory system based at least in part on transmitting the logical address.

19. A method at a memory system, comprising:
receiving, from a host system, a command for a set of data, and an address payload comprising an indication of a register, of the host system, that stores cryptography instructions for the set of data;
transmitting, to a cryptography engine of the host system, an indication of the command for the set of data, and the address payload comprising the indication of the register that stores the cryptography instructions; and
communicating, between the memory system and the host system, the set of data based at least in part on transmitting the indication of the command and the address payload comprising the indication of the register that stores the cryptography instructions, wherein the set of data is encrypted according to the cryptography instructions.

20. The method of claim 19, wherein the address payload comprises an address, for a volatile memory of the host system, from which the host system is to retrieve the set of data.

21. The method of claim 20, wherein the command is a command to write the set of data, and wherein communicating the set of data comprises:
receiving the set of data from the host system.

22. The method of claim 20, further comprising:
receiving a logical address associated with the encrypted set of data; and
writing the encrypted set of data to a set of memory cells mapped to the logical address.

23. The method of claim 19, wherein the address payload comprises an address, for a volatile memory of the host system, at which the host system is to store the set of data.

24. The method of claim 23, wherein the command is a command to read the set of data, and wherein communicating the set of data comprises:
transmitting the set of data to the host system.

25. The method of claim 23, further comprising:
receiving a logical address associated with the encrypted set of data; and
reading the encrypted set of data from a set of memory cells mapped to the logical address.
